(19) United States
(12) Patent Application Publication
(10) Pub. No.: US 2026/0098311 A1
(43) Pub. Date: Apr. 9, 2026

(54) HIDE TANNING PROCESS, METHOD FOR PREPARING LEATHER, AND DETANNING PROCESS

(71) Applicants: CTC, LYON (FR); Centre national de la recherche scientifique, PARIS (FR); Université de Montpellier, Montpellier (FR); ENSCM - ECOLE NATIONALE SUPERIEURE DE CHIMIE, MONTPELLIER (FR)

(72) Inventors: Titouan MONTHEIL, Lyon (FR); Thomas CASSENTI, Villeurbanne (FR); Gilles SUBRA, Saint Gely du Fesc (FR); Ahmad MEHDI, Montpellier (FR); Thierry PONCET, Villeurbanne (FR)

(21) Appl. No.: 19/114,198

(22) PCT Filed: Sep. 18, 2023
(86) PCT No.: PCT/FR2023/051416

§ 371 Date: Mar. 21, 2025

(30) Foreign Application Priority Data
Sep. 23, 2022 (FR) FR2209659

(51) Int. Cl. C14C 3/08

(52) U.S. Cl. CPC C14C 3/08

(57) ABSTRACT

A process for tanning hides using a tanning solution that includes a silicon compound and is free from metals. A method for preparing leathers is also related, the method including a tanning process. Also related are tanned hides obtained by such a tanning process and a process for detanning the hides obtained by this tanning process.

### CROSS-REFERENCE TO RELATED APPLICATIONS

This application is a 35 U.S.C. § 371 National Stage patent application of PCT/FR2023/051416 filed 18 Sep. 2023, which claims the benefit of French patent application 2209659 filed 23 Sep. 2022, the disclosures of which are incorporated herein by reference in their entirety.

### TECHNICAL FIELD

The present disclosure relates to a process for tanning hides using a silicon compound as a tanning agent, a method for preparing leathers implementing such a process. The present disclosure also relates to a process for detanning tanned hides and leathers thus obtained.

### BACKGROUND

Preparing leather from animal hides requires many steps. All of these steps can be classified into three large groups which can be defined as follows: i) the steps of preparing the hides, ii) the steps of tanning operations, and iii) the steps of grinding and finishing.

During the steps of preparing the hides, the raw hides of animals are received. These hides can be sorted according to their quality, their size, their weight, etc. During these preparation steps, the parts of the hides which are not desired to be kept, such as for example the legs, are cut out and removed. The hides are then cleaned. To do this, the hides are soaked in a large volume of water, for example in a fuller (rotating barrel) or in a sewing machine (stationary vessel with moving blades). An antiseptic can be added. Once cleaned, the hides are shaved to remove hair, for example by chemical means. The hides also undergo a fleshing step which consists of removing the subcutaneous tissues. These steps are called river steps.

At the end of the steps of preparing the hides, hides which can be so-called “pickled” hides or so-called “delimed” hides are obtained. The “pickled” hides are hides with high salinity and a low pH, generally less than 3.0. The “delimed” hides are hides coming out of the river steps with a pH generally comprised between 7.5 and 9.0.

During tanning operations, the hides prepared as indicated above, for example the “pickled” hides and the “delimed” hides, are degreased. If necessary, these hides are rehydrated. At this stage, the hides are putrescible and ready to be tanned. The tanning step itself consists of a chemical treatment allowing to transform these putrescible hides into non-putrescible and resistant leathers. The obtained leathers are then drained, rinsed and possibly spun.

The grinding and finishing steps are the steps which make it possible to make the leathers obtained at the end of the tanning operations usable for the manufacture of leather objects. These steps may comprise steps of spinning, thicknessing, stretching, retanning, dyeing, food. The finishing steps may comprise steps during which the leather is softened, smoothed, satin, printed, steps giving the leather, for example, properties of resistance to stains, abrasion, water or light. They can also give leathers aesthetic properties, such as shine, color, a velvety, satin or grained appearance, etc.

In the group of tanning operations described above, the key step is the tanning step itself, during which the hides ready to be tanned are tanned in order to be transformed into non-putrescible leathers thanks to the action of tanning agents. The hides are made up of collagen fibers. During tanning, the tanning agents form bonds between the collagen fibers of the hides, allowing to stabilize these hides and transforming them into strong, non-putrescible leather.

Since the publication of the European REACH regulation (Regulation (EC) No. 1907/2006 on the registration, evaluation, authorization and restriction of chemical substances), the marketing of consumer goods is increasingly more controlled, particularly with regard to chemical risks. The leather articles are no exception and must respect new constraints. In the leather industry, the most widely used tanning agent is chromium at oxidation state 3 (Cr³⁺). Indeed, the Cr³⁺ chrome tanning process is easy to implement, efficient and makes it possible to obtain leathers with properties that meet market expectations. Under certain conditions, a fraction of the Cr³⁺ present in certain leathers can be transformed into allergenic Cr⁶⁺ by dermal contact. For this reason, the European Union imposes a restriction on the marketing of articles whose Cr⁶⁺ content in the leathers in contact with the hide is greater than 3 mg/kg (EU regulation no 301/2014 amending Annex XVII of Regulation 1907/2006). The European Union is even considering lowering this threshold in the years to come. The leather industry is therefore looking for alternative solutions to chrome for tanning hides.

Glutaraldehyde can be used as a tanning agent: however, this compound has been classified as a Substance of Extreme Concern by ECHA (European Chemical Agency) as part of the European REACH regulation. The substance is a respiratory and dermal sensitizer.

The vegetable tannins can also be used for tanning hides. However, the large quantity of required product and the hardness of the resulting leathers limit the use of these tannins to specific applications.

Other tanning agents may be used, including metals such as aluminum, iron, titanium or zirconium, as well as synthetic organic compounds.

Furthermore, the manufacturing of leather or leather articles generates leather waste (shaving, sheeting, manufacturing scraps). When the hides have been tanned in the presence of chromium, this waste is difficult to recover.

Finally, the effluent from the chrome tanning process comprises unreacted chromium. Effluents must be treated before discharge into the natural environment.

Document U.S. Pat. No. 3,116,965 describes a process for tanning hides, using silatrioxanes.

### SUMMARY

Given the constraints described above, alternative solutions for tanning the hides are necessary for the sustainability of the leather sector. There therefore remains a need to have a process for tanning hides which would avoid the use of metals in general, and in particular chrome, in order to obtain leathers guaranteeing the safety of employees of companies in the leather sector, consumer protection (safety), recovery of leather waste (production scraps or end-of-life articles) and environmental protection. There remains therefore a need for a process for tanning hides allowing to obtain tanned hides capable of being easily detanned. There also remains a need for a process for detanning such hides, allowing to recover tanned hides and leathers.

The present disclosure relates to a process for tanning hides ready to be tanned comprising the following steps:
A) The hides ready to be tanned are soaked in a fuller in an aqueous solution and the pH of the hides and of the aqueous solution is brought to a value ranging from 1.5 to 10.5 by adding an acid or a base,
B) the hides from step A) are treated using a tanning solution consisting of, by mass relative to the mass of the hides:
   1 to 1200% of water,
   optionally, a sufficient quantity of salt to prevent swelling of the hides, and
   1 to 100% of a compound of formula (I):

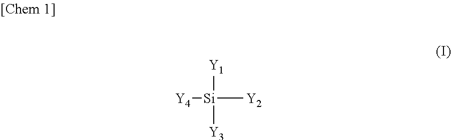

in which Y1, Y2, Y3 and Y4 are chosen independently of each other as a halogen atom, a —[OSiOₘR¹₃₋ₘ]ₙ group or an —OR² group, two or more —[OSiOₘR¹₃₋ₘ]ₙ and —OR² groups which can be connected to each other by a covalent bond, in which:
   m is an integer ranging from 0 to 3, n is an integer greater than or equal to one, and R¹ is chosen as a hydrogen atom, a C₁-C₁₀ alkyl group, an aryl group, a C₂-C₁₀ alkenyl group, a C₂-C₁₀ alkynyl group, a polyalkylene oxide group or its derivatives, R¹ being optionally substituted by one or several amine, ammonium, amide, ketone, ester, aldehyde, thiol or thioethers group,
   R² is chosen as a hydrogen atom, a C₁-C₁₀ alkyl group, an aryl group, a C₂-C₁₀ alkenyl group, a C₂-C₁₀ alkynyl group, a polyalkylene oxide group or its derivatives, R² being optionally substituted by one or several amine, ammonium, amide, ketone, ester, aldehyde, thiol or thioether groups,
   said hides being treated using said tanning solution until penetration of the hides by said tanning solution,
C) optionally, the pH of the hides obtained at the end of step B) is brought to a value ranging from 2.1 to 10.5, preferably ranging from 4.0 to 8.0.

The process according to the disclosure makes it possible to obtain tanned hides free of metals. In particular, the tanned hides obtained with the tanning process according to the disclosure are free of chromium. The hides obtained with the tanning process according to the disclosure have a satisfactory shrinkage temperature for the manufacture of leather articles (shoes, leather goods, gloves, automobiles, furniture).

These hides can thus be used to shape leather objects without risk to the health of future users of these objects, whatever the conditions of use of these objects. In particular, due to the exclusive use of silicon in the tanned hides obtained according to the process of the disclosure, these hides can be detanned so as to recovery them one again.

The present disclosure also relates to tanned hides capable of being obtained by the above tanning process.

The present disclosure also relates to a method for preparing leathers from raw hides comprising the following steps:
i) a step of preparing raw hides in order to obtain hides ready to be tanned,
ii) a step of tanning the hides ready to be tanned, said tanning step being carried out in accordance with the tanning process as described above,
iii) a step of grinding and/or finishing the tanned hides obtained at the end of step ii) in order to obtain finished leathers.

The present disclosure also relates to a process for detanning hides obtained by the tanning process as described above and/or finished leathers obtained according to the method for preparing leathers described above comprising at least one step during which said hides and/or leathers are soaked in a basifying solution in order to bring the pH of said hides and/or leathers to a value greater than or equal to 10.5, preferably to a value ranging from 11.5 to 13.0.

### DETAILED DESCRIPTION OF THE DISCLOSURE

The hides concerned by the tanning and detanning processes according to the disclosure can be any hides containing collagen, whether these hides are synthetic or natural. These hides can for example come from animals whose hide contains collagen, such as bovine, sheep, goat, reptiles (snakes, lizards, crocodilians, alligatoridae), fish, birds, amphibians, pigs.

In the tanning process according to the disclosure, the terms “hides ready to be tanned”, mean hides resulting from operations of preparing hides as described above, for example pickled or delimed hides, which have also been degreased.

The rehydration and degreasing operations are well known to those skilled in the art. For example, to rehydrate and degrease pickled hides, the hides can be placed in a fuller, water, salt and a degreaser can be added. The degreaser can in a known manner be chosen from surfactants, for example nonionic and anionic surfactants. For example, the fuller can be rotated without heat for a duration of 15 minutes to 10 hours, drain the fuller and then rinse the hides with salt water at room temperature. Hides ready to be tanned are thus obtained.

In the method for preparing leather according to the disclosure, the terms “raw hides” mean natural or synthetic hides containing collagen, but which have not yet undergone the steps of preparing the hides as described above, making these hides ready to be tanned.

According to a first step, step A), of the tanning process according to the disclosure, the hides ready to be tanned are soaked in a fuller in an aqueous solution and the pH of the hides and of the aqueous solution is brought to a value ranging from 1.5 to 10.5 by addition of an acid or of a base.

The fuller is a rotating drum well known to those skilled in the art. In the present application, the term fuller means any container configured to receive the hides to be tanned and provided with a system allowing the mixing of the hides and of the aqueous solution. Thus, a sewing machine falls within the definition of a fuller according to the present application. Depending on the pH value chosen to soak the hides, the aqueous solution may comprise a salt. This salt has the function of preventing swelling of the hides in the aqueous solution. For the purposes of this application, the term salt means an ionic compound of cations and anions forming a neutral product without a net electric charge. The salt can for example be chosen from potassium chloride, sodium chloride and mixtures thereof. For example, if the pH of the aqueous solution is less than 5.0 the aqueous solution will preferably comprise a salt. The preparation of such a salty solution is within the reach of those skilled in the art. Determining the quantity of salt, for example sodium chloride, necessary to prevent swelling of the hides is within the reach of those skilled in the art. By way of example, the aqueous solution may comprise from 1 to 1200% of water, by mass relative to the mass of the hides, and from 6 to 12% of sodium chloride, by mass relative to the mass of water.

The pH of the hides and of the aqueous solution is brought to a value ranging from 1.5 to 10.5 by adding an acid or a base.

In one embodiment, the pH of the hides and of the aqueous solution is brought to a value ranging from 1.5 to 2.0, preferably ranging from 1.7 to 1.9, for example by adding one or several acids used alone or in a mixture, for example by adding an acid chosen from formic acid, sulfuric acid and mixtures thereof. As will appear from the rest of the description, bringing the pH of the hides and of the aqueous solution to such an acidic pH makes it possible to add the tanning solution directly to the fuller in the form of a solution of the compound Si(OH)₄, the latter having been previously prepared outside the fuller from a compound of formula (I) above, for example from Si(OCH₂CH₃)₄. As will also emerge from the rest of the description, bringing the pH of the hides and of the aqueous solution to such an acidic pH also allows alternatively to prepare the tanning solution in-situ, in other words in the fuller, by adding a solution of the compound Si(OCH₂CH₃)₄.

In another embodiment, the pH of the hides and of the aqueous solution of step A) is brought to a value ranging from 2.1 to 10.5. As will appear from the rest of the description, bringing the pH of the hides and of the aqueous solution of step A) to a value ranging from 2.1 to 10.5 makes it possible to prepare the tanning solution in-situ, in other words in the fuller, by adding a solution of the compound Si(OCH₂CH₃)₄, while keeping a relatively high pH during the treatment step with the tanning solution, for example a pH of approximately 7.0, and free from a subsequent basification step. Likewise, when the treatment step with the tanning solution is made at a pH greater than or equal to 5.0, the addition of a salt to the tanning solution is not necessary.

According to a second step of the process according to the disclosure, step B), the hides of step A) are treated with a tanning solution. To do this, the aqueous solution from step A) can be evacuated from the fuller or not. In the case where the aqueous solution from step A) is evacuated from the fuller, this emptying is preferably done without rinsing the hides.

The tanning solution consists of, by mass relative to the mass of the hides:
1 to 1200% of water,
optionally, a sufficient quantity of salt, preferably sodium chloride, to prevent swelling of the hides, and
1 to 100% of a compound of formula (I):

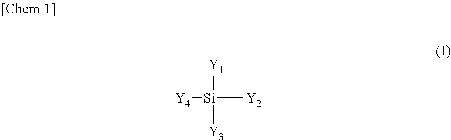

in which Y1, Y2, Y3 and Y4 are chosen independently of each other as a halogen atom, a —[OSiOₘR¹₃₋ₘ]ₙ group or an —OR² group, two or more —[OSiOₘR¹₃₋ₘ]ₙ and —OR² groups which can be connected to each other by a covalent bond, in which:
m is an integer ranging from 0 to 3, n is an integer greater than or equal to one, and R¹ is chosen as a hydrogen atom, a C₁-C₁₀ alkyl group, an aryl group, a C₂-C₁₀ alkenyl group, a C₂-C₁₀ alkynyl group, a polyalkylene oxide group or its derivatives, R¹ being optionally substituted by one or several amine, ammonium, amide, ketone, ester, aldehyde, thiol or thioether groups,
R² is chosen as a hydrogen atom, a C₁-C₁₀ alkyl group, an aryl group, a C₂-C₁₀ alkenyl group, a C₂-C₁₀ alkynyl group, a polyalkylene oxide group or its derivatives, R² being optionally substituted by one or several amine, ammonium, amide, ketone, ester, aldehyde, thiol or thioether groups.

For the purposes of the present disclosure:
“C₁-C₁₀ alkyl” group means a saturated, linear or branched, hydrocarbon chain including from 1 to 10 carbon atoms, such as for example a methyl, ethyl, isopropyl, tert-butyl, pentyl, etc. group.
aryl group means an aromatic group, preferably including from 5 to 10 carbon atoms, comprising one or several rings and optionally comprising a heteroatom, in particular an oxygen, a nitrogen or a sulfur, such as for example a phenyl, furan, indole, pyridine, naphthalene, etc. group.
“C₂-C₁₀ alkenyl” group means a linear or branched, hydrocarbon chain including at least one unsaturation and including from 2 to 10 carbon atoms, such as for example an ethenyl (vinyl), propenyl, 2,4-hexafienyl, etc. group.
“C₂-C₁₀ alkynyl” group means a linear or branched, hydrocarbon chain including at least one double unsaturation and including from 2 to 10 carbon atoms, such as for example an acetylene, propyne, butyne, etc. group.
“polyalkylene oxide” group means polymers of ethylene oxide units, the number of ethylene oxide units is an integer greater than or equal to 1,
Derivatives of polyalkylene oxides mean one or several synthetic polymers chosen from copolymers of carboxylic acids and carboxylic esters of poly(alkylene glycol), copolymers of carboxylic acids and poly(alkylene amide glycol), copolymers of carboxylic acids and poly(alkylene glycol) imide, copolymers of carboxylic acids and poly(alkylene glycol) vinyl ethers, neutralized or non-neutralized, and mixtures thereof.

The tanning solution is thus free of any metal other than silicon. In particular, the tanning solution is free of chromium.

In one embodiment, Y1, Y2, Y3 and Y4 are chosen independently of each other as a chlorine atom, an —OH group or an —OCH₂CH₃ group.

In one form of implementation of the process according to the disclosure, the compound of formula (I) is Si(OH)₄. In such a case, the pH of the hides and of the aqueous solution of step A) will have previously been brought to a value ranging from 1.5 to 2.0, preferably ranging from 1.7 to 1.9. The tanning solution can then consist of, by mass relative to the mass of the hides:
1 to 1200% of water,
A sufficient quantity of salt, preferably sodium chloride, to prevent swelling of the hides, and
5 to 60%, preferably 5 to 30%, more preferably 10 to 20%, of Si(OH)₄.

In such a form of implementation, the tanning solution is preferably prepared outside the fuller by hydrolysis of the compound Si(OCH₂CH₃)₄ into Si(OH)₄, the tanning solution then being added to the hides in the fuller. For example, the tanning solution can be prepared by mixing an aqueous solution with a pH ranging from 1.5 to 2.0 and Si(OCH₂CH₃)₄ in a volume ratio (v/v) ranging from 1/1 to 25/1, preferably ranging from 1/1 to 10/1.

The Si(OH)₄ thus obtained is added to the fuller, in a content, by mass relative to the mass of the hides, ranging from 5 to 60%, preferably from 5 to 30%, more preferably 10 to 20%. This content can be adjusted depending on the type of hides to be tanned and depending on the thickness of these hides. Furthermore, to prevent swelling of the hides, salt, such as for example sodium chloride, can also be added to the fuller, for example in a content, by mass relative to the mass of added Si(OH)₄, ranging from 6 to 12%.

It is possible to add more acidic salt water to the fuller. Ultimately, within the fuller, water can be present in a mass content relative to the mass of the hides, ranging from 1 to 1200%.

The fuller is preferably left to rotate for a duration allowing the silicic acid to penetrate the hides. This duration can thus vary depending on the thickness of the hides and the nature of the hides: for example, the penetration of the hide to be tanned with silicic acid may require a longer duration for a bovine hide than for a sheep hide. The duration of this step can be easily determined by those skilled in the art depending on the hide to be tanned. The rotation of the fuller is preferably made at room temperature, in other words a temperature less than or equal to 30° C., preferably a temperature ranging from 20 to 25° C.

Once the silicic acid has penetrated the hides, the hides can be taken directly out of the fuller and left to dry. In such a case, the hides are taken out of the fuller and left to dry at the end of step B). The water they contain evaporates during this drying step. This evaporation leads to the polymerization of Si(OH)₄ and the three-dimensional Si—O—Si network linked to the collagen of the hide is created, thus stabilizing the hide. At the end of this drying step, dried leathers which can be directly stored are obtained.

In an alternative embodiment, once the silicic acid has penetrated the hides, the pH of the latter is brought to a value ranging from 2.1 to 10.5, preferably ranging from 4.0 to 8.0. This optional step C) will be described below.

In another form of implementation of the process according to the disclosure, the compound of formula (I) is Si(OCH₂CH₃)₄.

The tanning solution can then consist of, by mass relative to the mass of the hides:
1 to 1200% of water,
A sufficient quantity of salt, preferably sodium chloride, to prevent swelling of the hides, and
5 to 100%, preferably 10 to 60%, more preferably 25 to 45%, of Si(OCH₂CH₃)₄.

In such an embodiment, the tanning solution can be produced directly in situ by adding Si(OCH₂CH₃)₄ to the fuller in a content, by mass relative to the mass of the hides, ranging from 5 to 100%, preferably ranging from 10 to 60%, more preferably ranging from 25 to 45%.

If necessary, it is possible to add more acidic salt water. Ultimately, within the fuller, water can be present in a mass content relative to the mass of the hides, ranging from 1 to 1200%.

In this embodiment, the hydrolysis of Si(OCH₂CH₃)₄ into Si(OH)₄ will thus take place within the fuller. When Si(OCH₂CH₃)₄ is added to the fuller, two insoluble phases are present in the fuller, water on the one hand, and Si(OCH₂CH₃)₄ on the other hand.

The fuller is preferably left to rotate for the duration necessary for the complete hydrolysis of Si(OCH₂CH₃)₄ into Si(OH)₄, in order to obtain a single soluble phase of silicic acid solution and to allow the silicic acid to penetrate the hides. For example, this duration can range from 1 hour to a week. As seen previously, the duration necessary for silicic acid to penetrate the hides may depend on the nature of the hides. This duration is easily determinable by those skilled in the art. The rotation of the fuller is preferably made at room temperature, in other words a temperature less than or equal to 30° C., preferably a temperature ranging from 20 to 25° C.

Furthermore, the duration of the complete hydrolysis of Si(OCH₂CH₃)₄ into Si(OH)₄ can also depend on the pH of the tanning solution.

Thus, in one embodiment, the compound of formula (I) is Si(OCH₂CH₃)₄ and the pH of the hides and of the aqueous solution of step A) will have previously been brought to a value ranging from 1.5 to 2.0, preferably ranging from 1.7 to 1.9. In this embodiment, once the silicic acid has penetrated the hides, the hides can be taken directly out of the fuller and dried, as described above. Alternatively, they can be subjected to a basifying treatment as will be described below.

In another embodiment, the compound of formula (I) is Si(OCH₂CH₃)₄ and the pH of the hides and of the aqueous solution of step A) will have previously been brought to a value ranging from 2.1 to 10.5. In such a case, the pH of the aqueous solution and of the hides is adjusted to a pH ranging from 2.1 to 10.5, preferably from 4.0 to 8.0, more preferably from 4.0 to 5.0 before adding the Si(OCH₂CH₃)₄ to the fuller as described above. The tanning solution thus has a pH ranging from 2.1 to 10.5, preferably from 4.0 to 8.0, more preferably from 4.0 to 5.0. Such a pH of the tanning solution makes it possible to have simultaneously in the fuller, on the one hand a hydrolysis reaction of Si(OCH₂CH₃)₄ into Si(OH)₄, and on the other hand a polymerization reaction of Si(OH)₄. The polymerization of Si(OH)₄ will lead to the formation of a three-dimensional Si—O—Si network, as well as the establishment of bonds with the collagen fibers of the hide. This three-dimensional network will make it possible to transform the initially putrescible hide into non-putrescible tanned hide and thus into stable and resistant leather. Thus, in the embodiment of the process according to the disclosure in which the pH of the tanning solution ranges from 2.1 to 10.5, preferably from 4.0 to 8.0, more preferably from 4.0 to 5.0, it is not obligatory to carry out an additional step, such as for example a specific step of basifying the hides so that they are tanned. In such an embodiment, the hides obtained at the end of step B) can be directly used for subsequent grinding steps or be dried to complete the polymerization and be stored. However, in an alternative embodiment of the process according to the disclosure in which the pH of the tanning solution ranges from 2.1 to 10.5, preferably from 4.0 to 8.0, more preferably from 4.0 at 5.0, it is possible to carry out a step of treating the hides with a basifying solution as described below.

Thus, in embodiments, the tanning process according to the disclosure may comprise an additional step, step C). During step C), the pH of the hides obtained at the end of step B) is brought to a value ranging from 2.1 to 10.5, preferably ranging from 4.0 to 8.0.

Thus, step C) is preferably implemented when the tanning solution is too acidic to trigger the polymerization of Si(OH)₄, for example when the pH of the tanning solution is less than or equal to 2.0.

During step C), the hides can for example be treated using a basifying solution. The basification of the bath containing the hides will allow and/or accelerate the polymerization of Si(OH)₄ within the hides. Bonds between the silicon and the collagen of the hide fibers will be able to be formed and a three-dimensional Si—O—Si network linked to the collagen of the hide will be able to be created, thus stabilizing the hides. Tanned hides will be obtained.

In one form of implementation of the process according to the disclosure, the treatment using a basifying solution is implemented inside the fuller by adding a basifying agent, for example chosen from sodium formate, sodium bicarbonate, sodium acetate, calcium formate, sodium carbonate and mixtures thereof, in a content, by mass relative to the mass of the hides, ranging from 0.5 to 20%.

In another embodiment, the treatment using a basifying solution can be implemented outside the fuller. For example, the treatment may comprise the following steps:
C1) at the end of step B), the hides are removed from the fuller,
C2) the hides are installed in a tank, placed flat, one on top of the other,
C3) the tank is filled with said basifying solution so as to completely immerse all of the hides, said basifying solution comprising a basifying agent chosen from sodium formate, sodium bicarbonate, sodium acetate, calcium formate, sodium carbonate and mixtures thereof,
C4) the hides are left in the basifying solution in the tank, to rest, for example for at least 1 hour.

The basifying agent content is calculated according to the desired final pH. During step C1), the hides can be taken out of the fuller with or without prior rinsing.

At any time during step C), the hides can be dried in order to carry out the polymerization of Si(OH)₄ by evaporation.

The hides obtained by the process according to the disclosure are tanned and non-putrescible. These hides generally have a white color. They have an appearance which makes them appear round and fuller than in their initial state before tanning. These hides have a shrinkage temperature ranging from 65 to 90° C. Such a shrinkage temperature allows these hides to be able to undergo treatments during which they can be subjected to relatively high temperatures, for example in the range of 50° C. to 75° C., such as thicknessing, hot dyeing for better fixation of dyes, etc. while keeping their flexibility and the quality of their appearance.

The present disclosure also relates to a method for preparing leathers from raw hides comprising the following steps:
i) a step of preparing the raw hides in order to obtain hides ready to be tanned,
ii) a step of tanning the hides ready to be tanned, said tanning step being carried out in accordance with the tanning process described above,
iii) a step of grinding and/or finishing the tanned hides obtained at the end of step ii) in order to obtain finished leathers.

The present disclosure also relates to a process for detanning the tanned hides obtained by the process described above and/or leathers obtained from the preparation method described above, comprising at least one step during which said hides and/or leathers are soaked in a basifying solution in order to bring the pH of said hides and/or leathers to a value greater than or equal to 10.5, preferably to a value ranging from 11.5 to 13.0.

In the detanning process according to the disclosure, the tanned hides can for example be in a “dry white” state. For the purposes of the present disclosure, the terms “dry white” mean a tanned, dried but not grinded hide. The tanned hides can alternatively be in the state of wet white, stain, crust, finished or semi-finished leather, shaving, sheeting, terms well known to those skilled in the art. The leather scraps and leather dust coming from wet white, “dry white”, stain, crust or finished leathers can also be detanned by the detanning process according to the disclosure.

For example, to carry out detanning, the tanned hides and/or the finished leathers can be soaked in an aqueous solution, for example in a fuller. When the tanned hides are in the form of leather scraps and leather dust, they can alternatively be placed in a vessel with a stirring blade or other mixing system. The aqueous solution may comprise a degreaser. For example, the aqueous solution may comprise, by mass relative to the mass of the hides:
from 50 to 2000% of water,
from 0.1 to 2% of a degreaser.

The degreaser can be chosen from surfactants, for example from nonionic and anionic surfactants.

The purpose of such a step is to degrease and rehydrate the hides and/or leathers. Preferably, the fuller is rotated for a duration allowing this degreasing and this rehydration, for example for a duration ranging from 15 min to overnight, for example from 45 min to 1 hour 30 mins, at a temperature ranging from 10 to 80° C., for example from 30 to 45° C.

The fuller can then be emptied and the hides and/or leathers can be rinsed in the fuller at room temperature.

The hides and/or leathers are soaked in an aqueous solution comprising a basifying agent in order to bring the pH of the hides and/or leathers to a value greater than or equal to 10.5, preferably to a value ranging from 11.5 at 13.0.

The basifying agent can for example be chosen from sodium bicarbonate, sodium carbonate, ammonia, sodium hydroxide and mixtures thereof.

The basifying agent can for example be added to the aqueous solution in several steps, with the use of different basifying agents or not for each step, and at a working temperature which can vary from one step to another.

For example, a first addition of basifying agent can bring the pH of the hides and/or leathers to a value ranging from 7.0 to 10.0. To do this, sodium bicarbonate, and/or sodium carbonate and/or ammonia are for example used, and the temperature of the aqueous solution is maintained at a value ranging from 10 to 80° C., for example ranging from 30 to 45° C.

Then a second addition of basifying agent can be carried out in order to bring the pH of the hides and/or leathers to a value ranging from 11.5 to 13.0. To do this, sodium hydroxide is for example used, and the temperature of the aqueous solution is maintained at a value ranging from 10 to 30° C., for example ranging from 20 to 25° C.

Bringing the hides and/or leathers to a pH greater than or equal to 10.5, preferably ranging from 11.5 to 13.0, results in the three-dimensional Si—O—Si network linked to the collagen of the hide breaking down. At such a pH, the hides and/or leathers, for example wet whites, “dry white”, stain, finished crust leathers, leather dust and scraps, lose their resistance to the shrinkage temperature: this loss indicates detanning of the hides and/or leathers.

Wet whites, “dry white”, stain, crust, finished leathers, shaving, sheeting, leather dust and scraps thus detanned can either remain in the form of non-crosslinked protein or be recovered once again, for example by being tanned again or by being used for the manufacture of gelatin, the manufacture of protein for animal feed or the manufacture of fertilizers for the fields, etc.

### EXPERIMENTAL PART

### Example 1

Preparation of Si(OH)₄ from Si(OCH₂CH₃)₄

1 L of Si(OCH₂CH₃)₄ is mixed with 1 L of water.

The pH of this mixture is adjusted to a value ranging from 1.5 to 2.0 using a strong acid, such as hydrochloric acid or sulfuric acid, this list not being exhaustive.

The hydrolysis reaction of Si(OCH₂CH₃)₄ into Si(OH)₄ is exothermic. Thus, preferably, the mixture is maintained at the desired temperature, for example around 30° C. by means of a cooling bath. Preferably, the mixture is stirred vigorously for 15 min to 120 min. The duration of the hydrolysis reaction can range from 20 min to 2 hours. At the end of this reaction, a clear solution of silicic acid is obtained, with the chemical formula Si(OH)₄. 10% by mass of sodium chloride is added, relative to the total mass of the silicic acid solution previously prepared.

### Example 2

Sheep hides are tanned according to the tanning process according to the disclosure as follows:

### Step A)

The hides ready to be tanned are pickled hides coming from a storage pickle or delimed hides previously degreased and rehydrated according to the know-how of those skilled in the art. The hides are weighed.

The hides are placed in a fuller in a salt solution. The pH of the hides and of the salt solution is brought to a value ranging from 1.5 to 2.0, for example by adding sulfuric acid alone or mixed with formic acid.

### Step B)

50% of cold water, at 25° C.,
5% of sodium chloride,
13% of Si(OH)₄ hydrolyzed from Si(OCH₂CH₃)₄ as described in Example 1, are added to the fuller, by mass relative to the mass of the hides.

The fuller is rotated for 4 hours at room temperature, i.e. 25° C.

### Step C)

Firstly, 5% of sodium formate by mass relative to the mass of the hides is added to the fuller at a temperature of 25° C. The fuller is rotated for 1 hour. The pH measured on the hides ranges from 3.8 to 4.0.

Secondly, 5% of sodium formate by mass relative to the mass of the hides is added to the fuller at a temperature of 25° C. The fuller is rotated for 1 night. The final pH measured on the hides ranges from 4.0 to 4.2.

The fuller is emptied and the hides are rinsed.

Tanned hides free of metals, in particular chromium, are obtained.

The hides are white, round and have a beautiful appearance.

### Example 3

Bovine hides are tanned according to the tanning process according to the disclosure as follows:

### Step A)

The hides ready to be tanned are pickled hides coming from a storage pickle or delimed hides previously degreased and rehydrated according to the know-how of those skilled in the art. The hides are weighed.

The hides are placed in a fuller in a salt solution. The pH of the hides and of the salt solution is brought to a value ranging from 1.5 to 2.0, for example by adding sulfuric acid alone or mixed with formic acid.

### Step B)

50% of cold water, at 25° C.,
5% of sodium chloride,
20% of Si(OH)₄ hydrolyzed from Si(OCH₂CH₃)₄ as described in Example 1, are added to the fuller, by mass relative to the mass of the hides.

The fuller is rotated overnight at room temperature, i.e. 25° C.

### Step C)

Firstly, 5% of sodium formate by mass relative to the mass of the hides is added to the fuller at a temperature of 25° C. The fuller is rotated for 1 hour. The pH measured on the hides ranges from 3.8 to 4.0.

Secondly, 5% of sodium formate by mass relative to the mass of the hides is added to the fuller at a temperature of 25° C. The fuller is rotated for 1 night. The final pH measured on the hides ranges from 4.0 to 4.2.

The fuller is emptied and the hides are rinsed.

Tanned hides free of metals, in particular chromium, are obtained.

The hides are white, round and have a beautiful appearance.

### Example 4

Sheep hides are tanned according to the tanning process according to the disclosure as follows:

### Step A)

The hides ready to be tanned are pickled hides coming from a storage pickle or delimed hides previously degreased and rehydrated according to the know-how of those skilled in the art. The hides are weighed.

The hides are placed in a fuller in a salt solution. The pH of the hides and of the salt solution is brought to a value ranging from 1.5 to 2.0, for example by adding sulfuric acid alone or mixed with formic acid.

### Step B)

50% of cold water, at 25° C.,
5% of sodium chloride,
13% of Si(OH)₄ hydrolyzed from Si(OCH₂CH₃)₄ as described in Example 1, are added to the fuller, by mass relative to the mass of the hides.

The fuller is rotated for 4 hours at room temperature, i.e. 25° C.

### Step C)

Firstly, 5% of sodium formate by mass relative to the mass of the hides is added to the fuller at a temperature of 25° C. The fuller is rotated for a duration of one minute and then stopped for 1 hour. The pH measured on the hides ranges from 3.8 to 4.0.

Secondly, 5% of sodium formate by mass relative to the mass of the hides is added to the fuller at a temperature of 25° C. The fuller is rotated for a duration of one minute and then stopped for 1 night. The final pH measured on the hides ranges from 4.0 to 4.2.

Tanned hides free of metals, in particular chromium, are obtained.

The hides are white, round and have a beautiful appearance.

### Example 5

Bovine hides are tanned according to the tanning process according to the disclosure as follows:

### Step A)

The hides ready to be tanned are pickled hides coming from a storage pickle or delimed hides previously degreased and rehydrated according to the know-how of those skilled in the art. The hides are weighed.

The hides are placed in a fuller in a salt solution. The pH of the hides and of the salt solution is brought to a value ranging from 1.5 to 2.0, for example by adding sulfuric acid alone or mixed with formic acid.

### Step B)

50% of cold water, at 25° C.,
5% of sodium chloride,
20% of Si(OH)₄ hydrolyzed from Si(OCH₂CH₃)₄ as described in Example 1, are added to the fuller, by mass relative to the mass of the hides.

The fuller is rotated overnight at room temperature, i.e. 25° C.

### Step C)

Firstly, 5% of sodium formate by mass relative to the mass of the hides is added to the fuller at a temperature of 25° C. The fuller is rotated for a duration of one minute and then stopped for 1 hour. The pH measured on the hides ranges from 3.8 to 4.0.

Secondly, 5% of sodium formate by mass relative to the mass of the hides is added to the fuller at a temperature of 25° C. The fuller is rotated for a duration of one minute and then stopped for 1 night. The final pH measured on the hides ranges from 4.0 to 4.2.

Tanned hides free of metals, in particular chromium, are obtained.

The hides are white, round and have a beautiful appearance.

### Example 6

Sheep hides are tanned according to the tanning process according to the disclosure as follows:

### Step A)

The hides ready to be tanned are pickled hides coming from a storage pickle or delimed hides previously degreased and rehydrated according to the know-how of those skilled in the art. The hides are weighed.

The hides are placed in a fuller in a salt solution. The pH of the hides and of the salt solution is brought to a value ranging from 1.5 to 2.0, for example by adding sulfuric acid alone or mixed with formic acid.

### Step B)

28% of Si(OCH₂CH₃)₄
are added to the fuller, by mass relative to the mass of the hides.

This quantity of Si(OCH₂CH₃)₄ represents the equivalent of 13% of Si(OH)₄ by mass relative to the mass of the hides.

The fuller is rotated for 4 hours at room temperature, i.e. 25° C.

Then:
150% of water at 25° C.
15% of sodium chloride
are added to the fuller, by mass relative to the mass of the hides.

The fuller is rotated for a duration of 20 minutes at 25° C.

### Step C)

Firstly, 5% of sodium formate by mass relative to the weight of the hides is added to the fuller at a temperature of 25° C. The fuller is rotated for 1 hour. The pH measured on the hides ranges from 3.8 to 4.0.

Secondly, 5% of sodium formate by mass relative to the weight of the hides is added to the fuller at a temperature of 25° C. The fuller is rotated for 1 night. The final pH measured on the hides ranges from 4.0 to 4.2.

The fuller is emptied and the hides are rinsed.

Tanned hides free of metals, in particular chromium, are obtained.

The hides are white, round and have a beautiful appearance.

### Example 7

Sheep hides are tanned according to the tanning process according to the disclosure as follows:

### Step A)

The hides ready to be tanned are pickled hides coming from a storage pickle or delimed hides previously degreased and rehydrated according to the know-how of those skilled in the art. The hides are weighed.

The hides are placed in a fuller in a salt solution. The pH of the hides and of the salt solution is brought to a value ranging from 1.5 to 2.0, for example by adding sulfuric acid alone or mixed with formic acid.

### Step B)

28% of Si(OCH₂CH₃)₄
are added to the fuller, by mass relative to the mass of the hides.

This quantity of Si(OCH₂CH₃)₄ represents the equivalent of 13% of Si(OH)₄ by mass relative to the mass of the hides.

The fuller is rotated for 4 hours at room temperature, i.e. 25° C. Then:
150% of water at 25° C.
15% of sodium chloride
are added to the fuller, by mass relative to the mass of the hides.

The fuller is rotated for a duration of 20 minutes at 25° C.

### Step C)

Firstly, 5% of sodium formate by mass relative to the weight of the hides is added to the fuller at a temperature of 25° C. The fuller is rotated for a duration of one minute and then stopped for 1 hour. The pH measured on the hides ranges from 3.8 to 4.0.

Secondly, 5% of sodium formate by mass relative to the weight of the hides is added to the fuller at a temperature of 25° C. The fuller is rotated for a duration of one minute and then stopped for 1 night. The final pH measured on the hides ranges from 4.0 to 4.2.

The fuller is emptied and the hides are rinsed.

Tanned hides free of metals, in particular chromium, are obtained.

The hides are white, round and have a beautiful appearance.

### Example 8

Bovine hides are tanned according to the tanning process according to the disclosure as follows:

### Step A)

The hides ready to be tanned are pickled hides coming from a storage pickle or delimed hides previously degreased and rehydrated according to the know-how of those skilled in the art. The hides are weighed.

The hides are placed in a fuller in a salt solution. The pH of the hides and of the salt solution is brought to a value ranging from 1.5 to 2.0, for example by adding sulfuric acid alone or mixed with formic acid.

### Step B)

Si(OH)₄ hydrolyzed from Si(OCH₂CH₃)₄ as described in Example 1 is added in several steps according to the following procedure. The percentages are given by mass relative to the mass of the hides:
Addition of 0.6% of Si(OH)₄ then rotation of the fuller for 4 hours at 25° C.,
Addition of 0.6% of Si(OH)₄ then rotation of the fuller for 4 hours at 25° C.,
Addition of 3.8% of Si(OH)₄ then rotation of the fuller overnight at 25° C.,
Addition of 5% of Si(OH)₄ then rotation of the fuller for 10 hours at 25° C.,
Addition of 5% of Si(OH)₄ then rotation of the fuller overnight at 25° C.,
Addition of 7.5% of Si(OH)₄ then rotation of the fuller for 24 hours at 25° C.,
Addition of 7.5% of Si(OH)₄ then rotation of the fuller for 24 hours at 25° C.

Then:
100% of water at 25° C.,
10% of sodium chloride at 25° C.
are added to the fuller, by mass relative to the mass of the hides.

The fuller is rotated for 20 minutes.

### Step C)

1.5% of sodium formate by weight relative to the weight of the hides is added to the fuller at a temperature of 25° C. The fuller is rotated for a duration of one minute every 30 minutes, for a duration of 12 hours. The pH measured on the hides is 3.88.

Then, 1.5% of sodium formate by mass relative to the mass of the hides is added to the fuller at a temperature of 25° C. The fuller is rotated for a duration of one minute every 30 minutes, for a duration of 12 hours. The pH measured on the hides is 4.40.

Then, 4% of sodium formate by mass relative to the mass of the hides is added to the fuller at a temperature of 25° C. The fuller is rotated for a duration of one minute every 30 minutes, for a duration of 6 hours. The pH measured on the hides is 4.50.

The fuller is emptied and the hides are rinsed.

Tanned hides free of metals, in particular chromium, are obtained.

The hides are white, round and have a beautiful appearance.

### Example 9

Sheep hides are tanned according to the tanning process according to the disclosure as follows:

### Step A)

The hides ready to be tanned are pickled hides coming from a storage pickle or delimed hides previously degreased and rehydrated according to the know-how of those skilled in the art. The hides are weighed.

The hides are placed in a fuller in a salt solution. The pH of the hides and of the salt solution is brought to a value ranging from 1.5 to 2.0, for example by adding sulfuric acid alone or mixed with formic acid.

### Step B)

50% of cold water, at 25° C.,
5% of sodium chloride,
13% of Si(OH)₄ hydrolyzed from Si(OCH₂CH₃)₄ as described in Example 1
are added to the fuller, by mass relative to the mass of the hides.

The fuller is rotated for 4 hours at room temperature, i.e. 25° C.

The fuller is emptied and the hides are rinsed.

### Step C)

The hides are taken out of the fuller and placed on a rack to drain for the time necessary for the surface water to evacuate. The hides are then framed damp and left to rest in the open air while they dry, generally overnight or a little longer depending on the thickness of the hide and the daily weather.

The next day, after the water contained in the hides has evaporated, they are dry, white and tanned.

### Example 10

Bovine hides are tanned according to the tanning process according to the disclosure as follows:

### Step A)

The hides ready to be tanned are pickled hides coming from a storage pickle or delimed hides previously degreased and rehydrated according to the know-how of those skilled in the art. The hides are weighed.

The hides are placed in a fuller in a salt solution. The pH of the hides and of the salt solution is brought to a value ranging from 1.5 to 2.0, for example by adding sulfuric acid alone or mixed with formic acid.

### Step B)

50% of cold water, at 25° C.,
5% of sodium chloride,
20% of Si(OH)₄ hydrolyzed from Si(OCH₂CH₃)₄ as described in Example 1, are added to the fuller, by mass relative to the mass of the hides.

The fuller is rotated overnight at room temperature, i.e. 25° C.

The fuller is emptied and the hides are rinsed.

### Step C)

The hides are taken out of the fuller and placed on a rack to drain for the time necessary for the surface water to evacuate. The hides are then framed damp and left to rest in the open air while they dry, generally overnight or a little longer depending on the thickness of the hide and the daily weather.

The next day, after the water contained in the hides has evaporated, they are dry, white and tanned.

### Example 11

Sheep hides are tanned according to the tanning process according to the disclosure as follows:

### Step A)

The hides ready to be tanned are pickled hides coming from a storage pickle or delimed hides previously degreased and rehydrated according to the know-how of those skilled in the art. The hides are weighed.

The hides are placed in a fuller in a salt solution. The pH of the hides and of the salt solution is brought to a value ranging from 2.1 to 10.5 for example by adding sulfuric acid alone or mixed with formic acid or by adding basifying agents.

### Step B)

The pH of the hides and of the salt solution is adjusted to a value ranging from 4.0 to 5.0, for example to 4.2.
28% of Si(OCH₂CH₃)₄
are added to the fuller, by mass relative to the mass of the hides.

This quantity of Si(OCH₂CH₃)₄ represents the equivalent of 13% of Si(OH)₄ by mass relative to the mass of the hides.

The fuller is rotated for a duration of 7 days at room temperature, i.e. at 25° C.

The fuller is then emptied and the hides are rinsed.

Tanned hides are obtained.

### Example 12

### Measurement of the Shrinkage Temperature

The shrinkage temperature for the tanned hides obtained in Examples 2 to 9 and 11 was measured according to the following protocol:
cut out a piece of tanned hide, approximately 2 cm by 1 cm, at the collar,
one side of the prepared sample is placed at the fixed zone of a retractometer,
the opposite side of the sample is placed at the mobile hook of the retractometer counterbalanced by a weight,
the retractometer containing the sample is placed in a beaker filled with cold water (temperature strictly below 25° C.): the hide sample must be completely immersed,
a thermometer is placed in the same beaker, fastened on the retractometer. The base of the thermometer is placed in front of the tanned hide sample,
the indicator arrow of the shrinkage is placed at zero,
The assembly (beaker filled with water+retractometer containing the sample+thermometer) is placed on a heating plate,
the heating plate is then turned on,
when the arrow, initially placed at zero, begins to move, the temperature value is recorded. This temperature indicates the moment when the hide shrinks.

The results obtained for the hides tanned according to above Examples 2 to 9 and 11 are brought together in the following Table I:

TABLE 1

| Example | Shrinkage temperature (in ° C.) |
|---|---|
| Example 2 | 74 |
| Example 3 | 75 |
| Example 4 | 73 |
| Example 5 | 75 |
| Example 6 | 73 |
| Example 7 | 73 |
| Example 8 | 74 |
| Example 9 | 72 |
| Example 11 | 73 |

### Table I: Shrinkage Temperature

The shrinkage temperatures of the hides tanned with the tanning process according to the disclosure are particularly satisfactory. Such shrinkage temperatures allow these hides to be suitable for undergoing treatments during which they can be subjected to relatively high temperatures, for example in the range of 50 to 75° C., such as thicknessing, hot dyeing for better fixation of dyes, etc. while keeping their flexibility and the quality of their appearance.

### Example 13

The hides obtained in above Examples 2 to 11 can be easily detanned, according to the detanning process according to the disclosure described below.

The tanned hides are introduced into a fuller. The hides are weighed. The mass will serve as a reference.
50 to 2000% of water,
0.1 to 2% of degreaser, are added to the fuller, by mass relative to the mass of the hides.

The fuller is rotated for a duration ranging from 15 minutes to overnight, ideally between 45 minutes and 1 hour 30 minutes, at a temperature ranging from 10 to 80° C., ideally from 30 to 45° C.

The fuller is emptied and the hides are rinsed at room temperature, i.e. 25° C.

A basifying agent chosen from sodium bicarbonate, sodium carbonate, ammonia and mixtures thereof is added to the fuller in order to bring the pH of the hides to a value ranging from 7.0 to 10.0, preferably to a value ranging from 8.0 to 9.0. The basifying agent is added at a content, by mass relative to the mass of the hides, ranging from 0.1 to 15%, preferably ranging from 1 to 5%.

The fuller is rotated for a duration ranging from 15 to 120 minutes, for example ranging from 45 to 90 minutes. The temperature ranges from 10 to 80° C., for example from 30 to 45° C.

Sodium hydroxide is then added to the fuller in order to bring the pH of the hides to a value greater than or equal to 10.5, preferably to a value ranging from 11.5 to 13.0. The fuller is rotated for a duration ranging from 30 minutes to 24 hours, for example overnight. The temperature ranges from 10 to 30° C., for example from 20 to 25° C.

During this step, the three-dimensional Si—O—Si network linked to the collagen of the hide is unraveled and the hides are detanned. The hides thus detanned can either remain in the form of non-crosslinked protein or be recovery one again. The detanned hides are free of metals, particularly chromium.

1. A process for tanning hides ready to be tanned comprising the following steps:
A) The hides ready to be tanned are soaked in a fuller in an aqueous solution and the pH of the hides and of the aqueous solution is brought to a value ranging from 1.5 to 10.5 by adding an acid or a base,
B) the hides from step A) are treated using a tanning solution consisting of, by mass relative to the mass of the hides:
1 to 1200% of water,
0 optionally, a sufficient quantity of salt to prevent swelling of the hides, and
1 to 100% of a compound of formula (I): 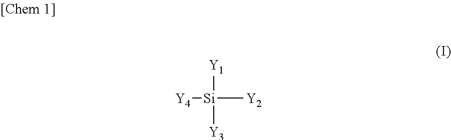
in which Y1, Y2, Y3 and Y4 are chosen independently of each other as a halogen atom, a —[OSiOₘR¹₃₋ₘ]ₙ group or an —OR² group, two or more —[OSiOₘR¹₃₋ₘ]ₙ and —OR² groups which can be connected to each other by a covalent bond, in which:
m is an integer ranging from 0 to 3, n is an integer greater than or equal to one, and R¹ is chosen as a hydrogen atom, a C₁-C₁₀ alkyl group, an aryl group, a C₂-C₁₀ alkenyl group, a C₂-C₁₀ alkynyl group, a polyalkylene oxide group or its derivatives, R¹ being optionally substituted by one or several amine, ammonium, amide, ketone, ester, aldehyde, thiol or thioether groups,
R² is chosen as a hydrogen atom, a C₁-C₁₀ alkyl group, an aryl group, a C₂-C₁₀ alkenyl group, a C₂-C₁₀ alkynyl group, a polyalkylene oxide group or its derivatives, R² being optionally substituted by one or several amine, ammonium, amide, ketone, ester, aldehyde, thiol or thioether groups,
said hides being treated using said tanning solution until penetration of the hides by said tanning solution,
C) optionally, the pH of the hides obtained at the end of step B) is brought to a value ranging from 2.1 to 10.5.

2. The process according to claim 1, wherein Y1, Y2, Y3 and Y4 are chosen independently of each other as a chlorine atom, an —OH group or an —OCH₂CH₃ group.

3. The process according to claim 1, wherein the pH of the hides and of the aqueous solution of step A) is brought to a value ranging from 1.5 to 2.0, for example by adding an acid chosen from formic acid, sulfuric acid and mixtures thereof.

4. The process according to claim 3, wherein the compound of formula (I) is Si(OH)₄.

5. The process according to claim 4, wherein the tanning solution consists of, by mass relative to the mass of the hides:
1 to 1200% of water,
A sufficient quantity of salt to prevent swelling of the hides, and
5 to 60% of Si(OH)₄.

6. The process according to claim 4, wherein, during the implementation of step B), the tanning solution is prepared outside the fuller by hydrolysis of the compound Si(OCH₂CH₃)₄ into Si(OH)₄, the tanning solution then being added to the hides in the fuller.

7. The process according to claim 6, wherein the tanning solution is prepared by mixing an aqueous solution with a pH ranging from 1.5 to 2.0 and Si(OCH₂CH₃)₄ in a volume ratio (v/v) ranging from 1/1 to 25/1.

8. The process according to claim 1, wherein the compound of formula (I) is Si(OCH₂CH₃)₄.

9. The process according to claim 8, wherein the tanning solution consists of, by mass relative to the mass of the hides:
1 to 1200% of water,
A sufficient quantity of salt to prevent swelling of the hides, and
5 to 100% of Si(OCH₂CH₃)₄.

10. The process according to claim 8, wherein, during the implementation of step B), the preparation of the tanning solution is carried out directly in situ by adding Si(OCH₂CH₃)₄ in a content, by mass relative to the mass of the hides, ranging from 5 to 100%.

11. The process according to claim 8, wherein the pH of the hides and of the aqueous solution of step A) is brought to a value ranging from 1.5 to 2.0, for example by adding an acid chosen from formic acid, sulfuric acid and mixtures thereof.

12. The process according to claim 8, wherein the pH of the hides and of the aqueous solution of step A) is brought to a value ranging from 2.1 to 10.5.

13. The process according to claim 12, wherein the pH of the aqueous solution and of the hides is adjusted to a pH ranging from 2.1 to 10.5 before adding Si(OCH₂CH₃)₄ to the fuller.

14. The process according to claim 1, wherein the hides are taken out of the fuller and left to dry at the end of step B).

15. The process according to claim 1, wherein the process further comprises step C).

16. The process according to claim 15, wherein, during step C), the hides are treated using a basifying solution.

17. The process according to claim 16, wherein step C) is implemented inside the fuller by adding a basifying agent chosen from sodium formate, sodium bicarbonate, sodium acetate, calcium formate, sodium carbonate and mixtures thereof, in a content, by mass relative to the mass of the hides, ranging from 0.5 to 20%.

18. The process according to claim 16, wherein step C) is implemented outside the fuller and comprises the following steps:
C1) at the end of step B), the hides are taken out of the fuller,
C2) the hides are installed in a tank, placed flat, one on top of the other,
C3) the tank is filled with said basifying solution so as to completely immerse all of the hides, said basifying solution comprising a basifying agent chosen from sodium formate, sodium bicarbonate, sodium acetate, calcium formate, sodium carbonate and mixtures thereof,
C4) the hides are left in the basifying solution in the tank, to rest, for example for at least 1 hour.

19. The process according to claim 18, wherein the basifying agent is chosen from sodium bicarbonate, sodium carbonate and mixtures thereof, and is present in the basifying solution in a content, by mass relative to the mass hides, ranging from 0.1 to 10%.

20. Tanned hides capable of being obtained by the tanning process according to claim 1.

21. A method for preparing leathers from raw hides comprising the following steps:
i) a step of preparing the raw hides in order to obtain hides ready to be tanned,
ii) a step of tanning the hides ready to be tanned, said tanning step being carried out in accordance with the tanning process according to claim 1,
iii) a step of grinding and/or finishing the tanned hides obtained at the end of step ii) in order to obtain finished leathers.

22. A process for detanning hides according to claim 20, comprising at least one step during which said hides and/or leathers are soaked in a basifying solution in order to bring the pH of said hides and/or leathers to a value greater than or equal to 10.5.
